(19) United States
(12) Patent Application Publication
(10) Pub. No.: US 2025/0181908 A1
(43) Pub. Date: Jun. 5, 2025

(54) MODEL-INDEPENDENT DATA SUBSETS

(71) Applicants: International Business Machines Corporation, Armonk, NY (US); Board of Regents, The University of Texas System, Austin, TX (US)

(72) Inventors: Krishnateja Killamsetty, Richardson, TX (US); Alexandre Evfimievski, Los Gatos, CA (US); Tejaswini Pedapati, White Plains, NY (US); Kiran A Kate, Chappaqua, NY (US); Lucian Popa, San Jose, CA (US); Rishabh Krishnan Iyer, Mckinney, TX (US)

(21) Appl. No.: 18/523,958

(22) Filed: Nov. 30, 2023

(51) Int. Cl. G06N 3/08

(52) U.S. Cl. CPC G06N 3/08

(57) ABSTRACT

Embodiments of the invention provide a computer-implemented method that uses a processor system to perform processor system operations. The processor system operations include executing a model-independent selection (MIS) algorithm to select a first data subset from a first dataset based at least in part on one or more data quality metrics. The one or more data quality metrics include a first data quality metric that results from using a first function to map first data points of the first dataset to the first data quality metric. Executing the MIS algorithm to select the first data subset is further based at least in part on sampling the first data subset from the first dataset based on a probability distribution. The processor system operations further include providing the first data subset to a to-be-trained (TBT) model. The first function is independent of a type of the TBT model.

### STATEMENT REGARDING PRIOR DISCLOSURE BY THE INVENTORS

The following disclosure is submitted under 35 U.S.C. 102 (b)(1)(A): DISCLOSURE: “MILO: Model-Agnostic Subset Selection Framework for Efficient Model Training and Tuning”, K. Killamsetty et al.; arXiv: 2301.13287v4 [cs.LG] 16 Jun. 2023; 37 pages.

### BACKGROUND

The present invention relates in general to programmable computers used to create and execute neural network models. More specifically, the present invention relates to computer-implemented methods, computing systems, and computer program products that implement novel algorithms that efficiently select model-independent data subsets from larger dataset. In aspects of the invention, the efficiently-selected data subsets are used to streamline the training of one or more models.

In its simplest form, artificial intelligence (AI) is a field that combines computer science and robust datasets to enable problem-solving. In general, AI refers to the broad category of machines that can mimic human cognitive skills. AI also encompasses the sub-fields of machine learning and deep learning. AI systems can be implemented as AI algorithms that perform as cognitive systems that make predictions or classifications based on input data.

A specific category of machines that can mimic human cognitive skills is NNs. In general, a NN is a network of artificial neurons or nodes inspired by the biological neural networks of the human brain. The artificial neurons/nodes of a NN are organized in layers and typically include input layers, hidden layers and output layers. Machine learning differ from deep learning in that deep learning has more hidden layers than machine learning. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0s) and ones (1s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

Data science combines math and statistics, specialized programming, advanced analytics, artificial intelligence (AI), and machine learning (ML) with specific subject matter expertise to uncover actionable insights hidden in an organization's data. These insights can be used to guide decision making and strategic planning. For example, a NN can be trained to solve a given problem on a given set of inputs. NN training is the process of teaching a NN to perform a task. NNs learn by initially processing several large sets of labeled or unlabeled data. By using these examples, NNs can “learn” to process unknown inputs more accurately. In a conventional scenario, the ability to create NNs to solve problems is limited by the availability of suitable training data sets.

### SUMMARY

Embodiments of the invention provide a computer-implemented method operable to use a processor system electronically coupled to a memory to perform processor system operations. The processor system operations include executing a model-independent selection (MIS) algorithm to select a first data subset from a first dataset based at least in part on one or more data quality metrics. The one or more data quality metrics include a first data quality metric that results from using a first function to map first data points of the first dataset to the first data quality metric. Executing the MIS algorithm to select the first data subset from the first dataset is further based at least in part on sampling the first data subset from the first dataset based on a probability distribution. The processor system operations further include providing the first data subset to a to-be-trained (TBT) model. The first function is independent of a type of the TBT model.

Embodiments of the invention are also directed to computer systems and computer program products having substantially the same features and functionality as the computer-implemented method described above.

Embodiments of the invention further provide a computer program product that includes a computer readable program stored on a computer readable storage medium. The computer readable program, when executed on a processor system, causes the processor system to perform processor system operations that include executing a MIS algorithm to select a first data subset from a first dataset based at least in part on one or more data quality metrics. The one or more data quality metrics include a first data quality metric that results from using a first function to map first data points of the first dataset to the first data quality metric. The processor operations further include providing the first data subset to a TBT model. The first function is independent of a type of the TBT model. Executing the MIS algorithm to select the first data subset from the first dataset is further based at least in part on sampling the first data subset from the first dataset based on a probability distribution having a bias toward achieving a greater value of the first data quality metric. The one or more data quality metrics further include a second data quality metric that results from using a second function to map second data points of the first dataset to the second data quality metric. The second function is independent of the type of the TBT model. The first data quality metric is associated with a first model-training characteristic (MTC). The second data quality metric is associated with a second MTC. The first MTC is different from the second MTC. Executing the MIS algorithm to select the first data subset from the first dataset is further based at least in part on the first MTC and the second MTC. Executing the MIS algorithm to select the first data subset from the first dataset is further based at least in part on one or more data selection constraints. The one or more data selection constraints include a training stage associated with the TBT model.

Embodiments of the invention are also directed to computer-implemented methods and computer systems having substantially the same features and functionality as the computer program product described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a simplified block diagram illustrating a model of a biological neuron operable to be utilized in neural network (NN) architectures in accordance with aspects of the invention;

FIG. 2B depicts a simplified block diagram illustrating a deep learning NN architecture in accordance with aspects of the invention;

FIG. 3 depicts a diagram illustrating a non-limiting example of a dimensionality reduction operation operable to utilize word embeddings in accordance with embodiments of the invention;

FIG. 4A depicts a simplified block diagram illustrating a non-limiting example of a transformer NN architecture operable to implement aspects of the invention;

FIG. 4B depicts a simplified block diagram illustrating a non-limiting example of an encoder element of a transformer NN architecture operable to implement aspects of the invention;

FIG. 4C depicts a simplified block diagram illustrating a non-limiting example of a decoder element of a transformer NN architecture operable to implement aspects of the invention;

FIG. 5 depicts a simplified block diagram illustrating a non-limiting example of a system in accordance with aspects of the invention;

FIG. 6 depicts a simplified block diagram illustrating a non-limiting example of a system in accordance with aspects of the invention;

FIG. 7 depicts a flow diagram illustrating a computer-implemented methodology in accordance with aspects of the invention;

FIG. 8 depicts a simplified block diagram illustrating aspects of the invention;

FIG. 9 depicts a simplified block diagram illustrating aspects of the invention;

FIG. 10 depicts a simplified block diagram illustrating aspects of the invention;

FIG. 11 depicts a simplified diagram illustrating a model-independent probability distribution function (or sampling technique) in accordance with aspects of the invention;

FIG. 12 depicts a non-limiting example of a stochastic greedy exploration (SGE) analysis that can be used in accordance with embodiments of the invention;

FIG. 13 depicts a non-limiting example of a SGE algorithm that can be used in accordance with embodiments of the invention;

FIG. 14 depicts a non-limiting example of a weighted random exploration (WRE) analysis that can be used in accordance with embodiments of the invention;

FIG. 15 depicts a simplified block diagram illustrating a non-limiting example of a system in accordance with aspects of the invention;

FIG. 16 depicts a simplified block diagram illustrating a non-limiting example of a system in accordance with aspects of the invention; and

FIG. 17 depicts a simplified block diagram illustrating a non-limiting example of a system in accordance with aspects of the invention.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components, modules, sub-function, and the like of the systems illustrated herein are depicted separately for ease of illustration and explanation. In embodiments of the invention, the operations performed by the various components, modules, sub-functions, and the like can be distributed differently than shown without departing from the scope of the various embodiments of the invention describe herein unless it is specifically stated otherwise.

For convenience, some of the technical operations described herein are conveyed using informal expressions. For example, a processor that has key data stored in its cache memory can be described as the processor “knowing” the key data. Similarly, a user sending a load-data command to a processor can be described as the user “telling” the processor to load data. It is understood that any such informal expressions in this detailed description should be read to cover, and a person skilled in the relevant art would understand such informal expressions to cover, the informal expression's corresponding formal and technical description.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

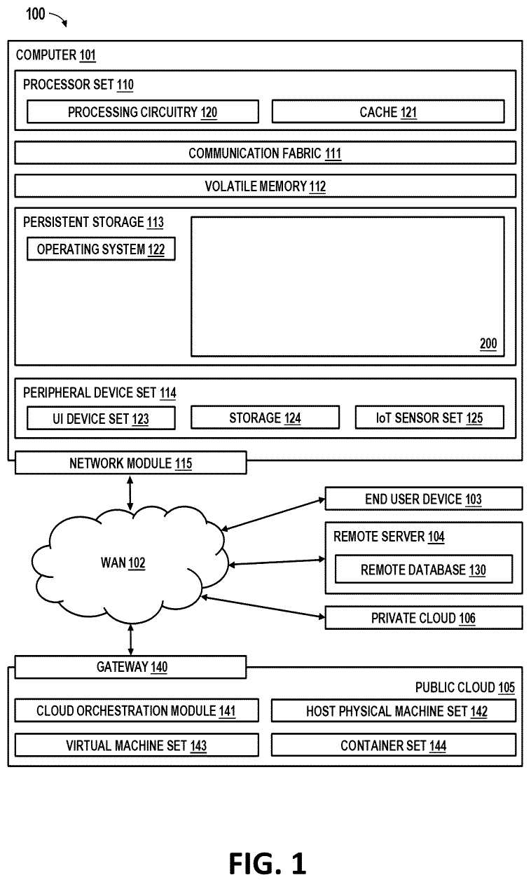

FIG. 1 depicts a computing environment 100 that contains an example of an environment for the execution of at least some of the computer code involved in performing the inventive methods, such as code block 200 operable to implement novel algorithms that efficiently select model-independent data subsets (or sample subsets) from larger datasets using probability distribution techniques. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

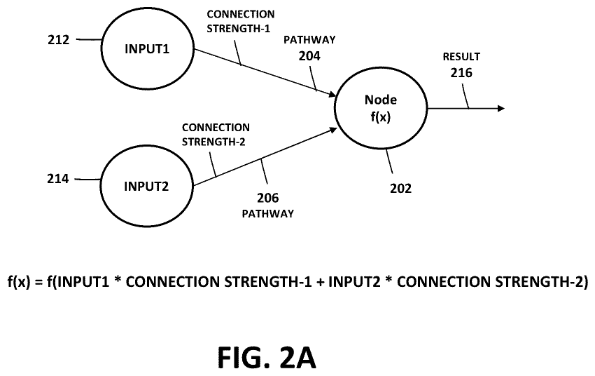

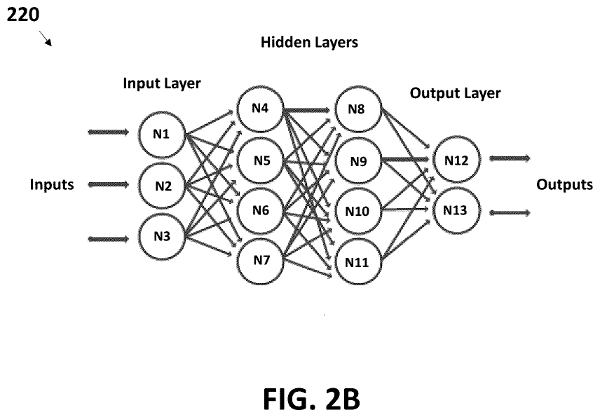

Embodiments of the invention can be implemented using NNs, which are a specific category of machines that can mimic human cognitive skills. In general, a NN is a network of artificial neurons or nodes inspired by the biological neural networks of the human brain. In FIG. 2A, the biological neuron is modeled as a node 202 having a mathematical function, f(x), depicted by the equation shown in FIG. 2A. Node 202 receives electrical signals from inputs 212, 214, multiplies each of the inputs 212, 214 by the strength of its respective connection pathway 204, 206, takes a sum of the inputs, passes the sum through a function, f(x), and generates a result 216, which may be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 2B depicts a simplified example of a deep learning NN architecture (or model) 220. In general, NNs can be implemented as a set of algorithms running on a programmable computer (e.g., computing environment 100 shown in FIG. 1). In some instances, NNs are implemented on an electronic neuromorphic machine (e.g., the IBM®/DARPA SyNAPSE computer chip) that attempts to create connections between processing elements that are substantially the functional equivalent of the synapse connections between brain neurons. In either implementation, NNs incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a NN is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The NN is “trained” by performing multiple iterations of learning-based analysis on the real-world data vectors until patterns (or relationships) contained in the real-world data vectors are uncovered and learned.

NNs use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a NN can be used to perform a variety of tasks, two of the more common tasks are labeling (or classification) of real-world data and determining the similarity between segments of real-world data. Classification tasks often depend on the use of labeled datasets to train the NN to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Similarity tasks apply similarity techniques and (optionally) confidence levels (CLs) to determine a numerical representation of the similarity between a pair of items.

Returning again to FIG. 2B, the simplified NN architecture/model 220 is organized as a weighted directed graph, wherein the artificial neurons are nodes (e.g., N1-N13), and wherein weighted directed edges (i.e., directional arrows) connect the nodes. The NN architecture/model 220 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. Multiple hidden layers indicates that the NN architecture/model 220 is a deep learning NN architecture/model. Each node is connected to every node in the adjacent layer by connection pathways, which are depicted in FIG. 2B as directional arrows each having its own connection strength. For ease of illustration and explanation, one input layer, two hidden layers, and one output layer are shown in FIG. 2B. However, in practice, multiple input layers, multiple hidden layers, and multiple output layers can be provided. When multiple hidden layers are provided, the NN model 220 can perform unsupervised deep-learning for executing classification/similarity type tasks.

Similar to the functionality of a human brain, each input layer node N1, N2, N3 of the NN 220 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The NN model 220 can be implemented as a feedforward NN or a recurrent NN. A feedforward NN is characterized by the direction of the flow of information between its layers. In a feedforward NN, information flow is unidirectional, which means the information in the model flows in only one direction—forward—from the input nodes, through the hidden nodes (if any) and to the output nodes, without any cycles or loops. In contrast to recurrent NNs, which have a bi-directional information flow, feedforward NNs are trained using the backpropagation method.

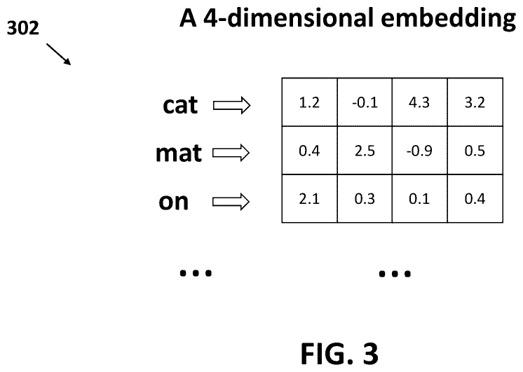

Some embodiments of the invention utilize and leverage embedding spaces. An embedding is a relatively low-dimensional space into which high-dimensional vectors can be translated. Embeddings make it easier to apply machine learning to large inputs like sparse vectors representing words. FIG. 3 illustrates the concept of embedding using an example word embedding 302. In general, NN models take vectors (i.e., an array of numbers) as inputs. Where the inputs are natural language symbols, token/word vectorization refers to techniques that extract information from the natural language symbol corpus and associate to each word of the natural language symbol corpus a vector using a suitable vectorization algorithm that takes into account the word's context.

Embeddings are a way to use an efficient, dense vector-based representation in which similar words have a similar encoding. In general, an embedding is a dense vector of floating-point values. In a word embedding, words are represented by dense vectors where a vector represents the projection of the word into a continuous vector space. The length of the vector is a parameter that must be specified. However, the values of the embeddings are trainable parameters (i.e., weights learned by the model during training in the same way a model learns weights for a dense layer). More specifically, the position of a word within the vector space of an embedding is learned from text in the relevant language domain and is based on the words that surround the word when it is used. The position of a word in the learned vector space of the word embedding is referred to as its embedding.

FIG. 3 depicts an example diagram of a word embedding 302 in an English language domain. As shown in FIG. 3, each word is represented as a 4-dimensional vector of floating-point values. Another way to think of the word embedding 302 is as a “lookup table.” After the weights have been learned, each word can be encoded by looking up the dense vector it corresponds to in the table. The embedding layer (or lookup table) maps from integer indices (which stand for specific words) to dense vectors (their embeddings). The dimensionality (or width) of the embedding is a parameter that can be selected to match the task for which it is designed. When an embedding layer is created, the weights for the embeddings are randomly initialized (just like any other layer). During training, the weights are gradually adjusted via back-propagation training techniques. Once trained, the learned word embeddings will roughly encode similarities between words (as they were learned for the specific problem on which the model is trained). The general techniques used in word embedding apply to embeddings in other domains, including domains used in embodiments of the invention.

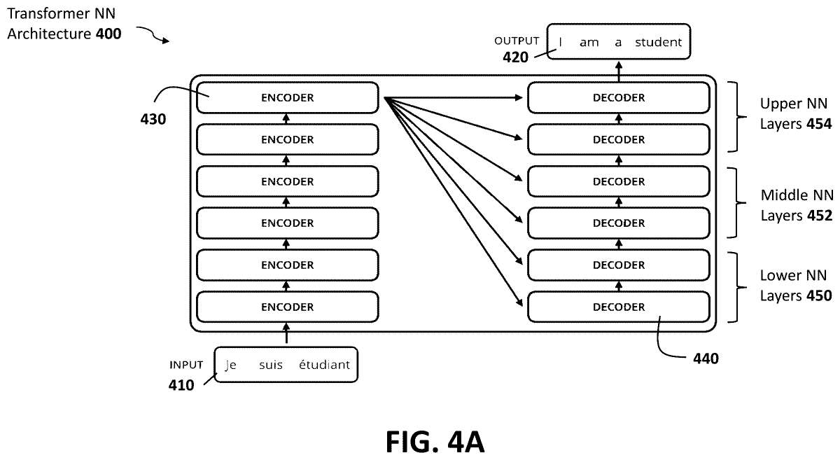

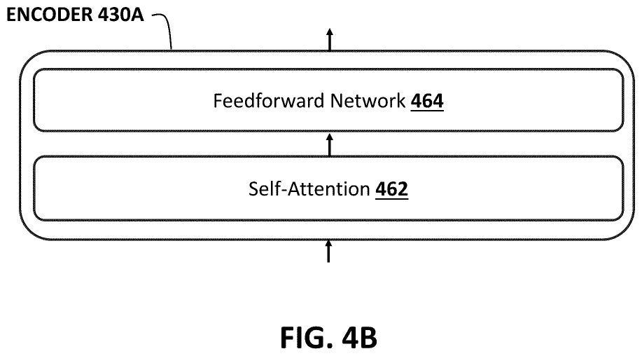

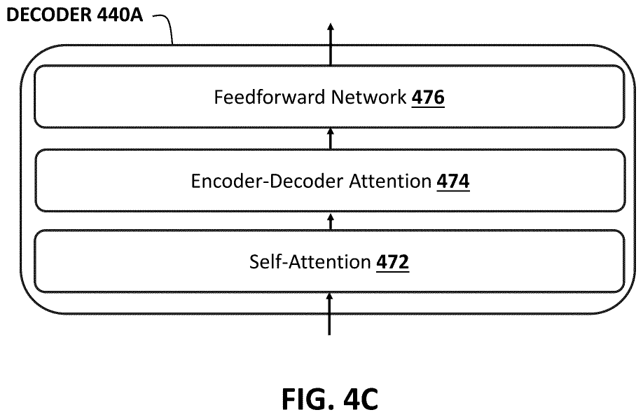

FIGS. 4A, 4B and 4C depict a non-limiting example of various aspects of a transformer NN architecture 400 that can be utilized to implement some aspects of the invention. More specifically, FIG. 4A depicts a simplified block diagram illustrating a non-limiting example of the transformer NN architecture 400; FIG. 4B depicts a simplified block diagram illustrating a non-limiting example of an encoder 430A of the transformer NN architecture 400; and FIG. 4C depicts a simplified block diagram illustrating a non-limiting example of a decoder 440A of the transformer NN architecture 400.

The transformer NN architecture 400 includes tokenization and embedding features. In embodiments of the invention, the transformer NN architecture 400 converts text and other data to vectors and back using tokenization, positional encoding, and embedding layers. The transformer NN architecture 400 is a sequence-to-sequence NN architecture in which input text is encoded with tokenizers to sequences of integers called input tokens. Input tokens are mapped to sequences of vectors (e.g., word embeddings) via embeddings layers. Output vectors (embeddings) can be classified to a sequence of tokens, and output tokens can then be decoded back to text.

More generally, tokenization is cutting input data into parts (symbols) that can be mapped (embedded) into a vector space. For example, input text is split into frequent words, which is an example of transformer tokenization. In some instances, special tokens can be appended to the sequence (e.g., class tokens) used for classification embeddings. Positional encodings add token order information. Self-attention and feed-forward layers are symmetrical with respect to the input so positional information is provided about each input token so positional encodings or embeddings are added to token embeddings in transformer encodings. Accordingly, embeddings are learned and/or trained.

As shown in FIG. 4A, the transformer NN architecture 400 includes a series or sequence of encoders 430 and a sequence of decoders 440 configured and arranged as shown. The encoders 430 and decoders 440 are organized around groups of layers including lower NN layers 450, middle NN layers 452, and upper NN layers 454. The transformer NN architecture 400 receives and input 410 (e.g., a sentence in French), uses the encoders 430 and the decoders 440 to perform a task (e.g., translating a French sentence to an English sentence), and, responsive to the input 410 generate an output 420 (e.g., an English translation of a French sentence). More specifically, the encoders 430 are configured and arranged to take the input 410, for example a sentence (i.e., sequences) written in French, and mapping it to high-dimensional representation(s). The encoders 430 are configured to “learn” the parts of the input 410 (i.e., the sequence) that are important and pass them to the high-dimensional representation, and the less-important aspects of the input 410 (e.g., the sequence) are left out. At this stage, the high-dimensional representation cannot be easily understood because there are no semantics involved and the complete mapping has not yet been learned.

The decoders 440 are configured to convert the high-dimensional representation into the output 420, which, in this example, is a sequence (e.g., a sequence written in English). Utilizing the encoders 430 and the decoders 440 allows models to be built that can transduce (i.e., map without losing semantics) “one way” into “another,” e.g., French into English. By training the encoders 430 and the decoders 440 together, a sequence-to-sequence model is created. A sequence-to-sequence model is capable of ingesting a sequence of a particular kind and outputting another sequence of another kind.

In embodiments of the invention, the transformer NN architecture 400 (also known as a generative language model) can be trained to perform the various tasks described herein. In the transformer NN architecture 400, the encoders 430 can be organized in layers (e.g., lower NN layers 450, middle NN layers 452, and upper NN layers 454) that process the input 410 iteratively one layer after another; and the encoders 440 can also be organized in corresponding layers (e.g., lower NN layers 450, middle NN layers 452, and upper NN layers 454) that do the same thing to the output of the last encoder 430. The function of each encoder 430 in a given layer is to process its input to generate encodings that contain information about which parts of the inputs are relevant to each other. The encoder 430 in one layer passes its set of encodings to the encoder 430 in the next layer as inputs. Each decoder 440 in a corresponding layer does the opposite, taking the output from the last encoder 430 and processing them, using their incorporated contextual information, to generate the output 420. To achieve this, each encoder 430 of a given layer makes use of an attention mechanism (e.g., self-attention 462 shown in FIG. 4B). In the context of NNs, an attention mechanism is a technique that electronically mimics human cognitive attention. The effect enhances the important parts of the input data and fades out the rest such that the NN devotes more computing power on that small but important part of the data. The part of the data that is more important than other parts of the data depends on the context and is learned through training data by gradient descent. Thus, the attention mechanism of the transformer NN architecture 400 weighs the relevance of every other input and draws information from them accordingly to produce the output. Each decoder 440 can include an additional attention mechanism (e.g., self-attention 472 and encoder-decoder attention 474 shown in FIG. 4C) that draws information from the outputs of previous decoders 440 before the current decoder 440 draws information from the encodings. The encoders 430 and the decoders 440 each include a feedforward network (e.g., feedforward network 464 shown in FIG. 4B, and feedforward network 476 shown in FIG. 4C) for additional processing of the outputs, and also contain residual connections and layer normalization steps.

FIG. 4B depicts a simplified block diagram illustrating a non-limiting example of how the encoder 430 (shown in FIG. 4A) can be implemented as the encoder 430A; and FIG. 4C depicts a simplified block diagram illustrating a non-limiting example of how the decoder 440 (shown in FIG. 4A) can be implemented as the decoder 440A. The encoders 430 are very similar to each other, and the decoders 440 are very similar to each other, as well. As shown in FIG. 4B, each encoder 430A includes two sub-layers, namely, a self-attention 462 and a feedforward network 464. The inputs to the encoder 430A first flow through the self-attention 462, which helps the encoder 430A look at other parts of the input 410 as it encodes a specific word. The decoder 440A shown in FIG. 4C has a corresponding self-attention 472 and feedforward network 476 that perform substantially the same functions in the decoder 440A as the self-attention 462 and the feedforward network 464 perform in the encoder 430A. The decoder 440A further includes encoder-decoder attention 474 that helps the decoder 440A focus on relevant parts of the input sentence.

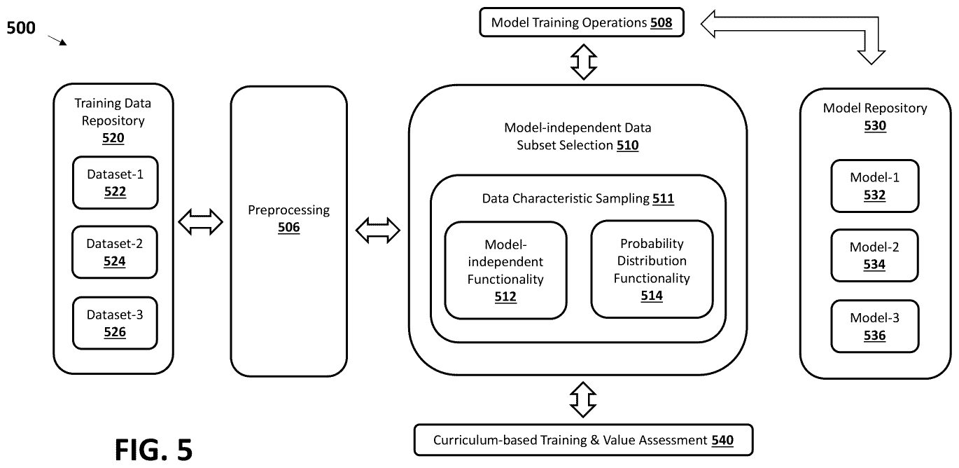

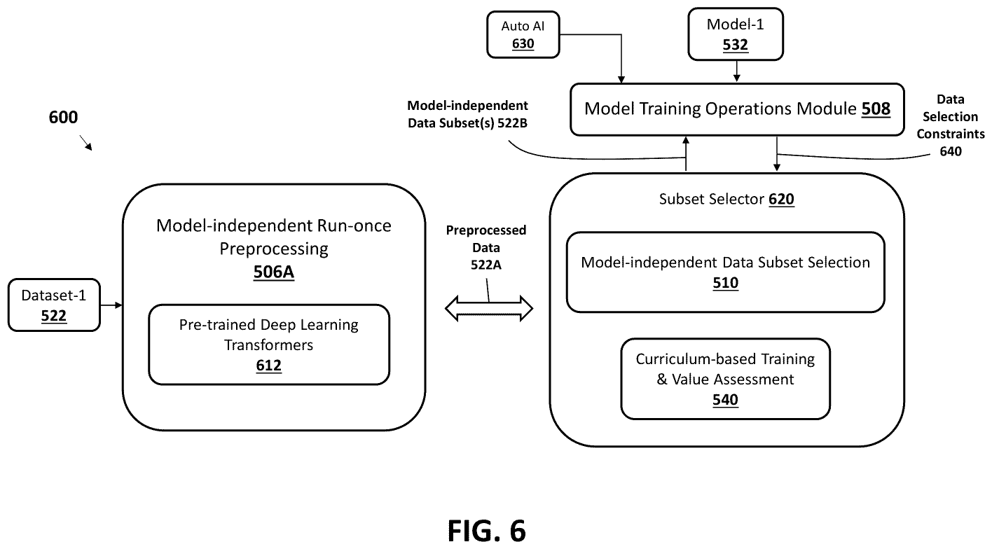

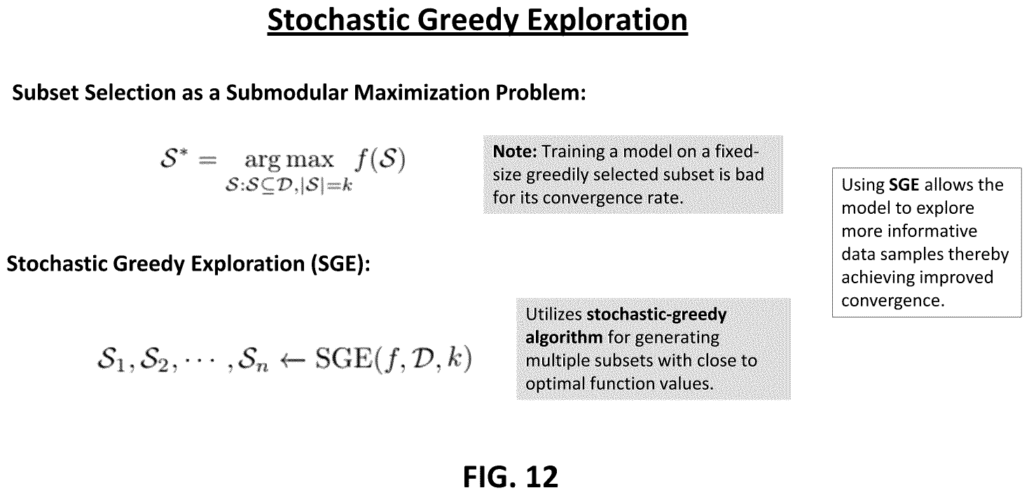

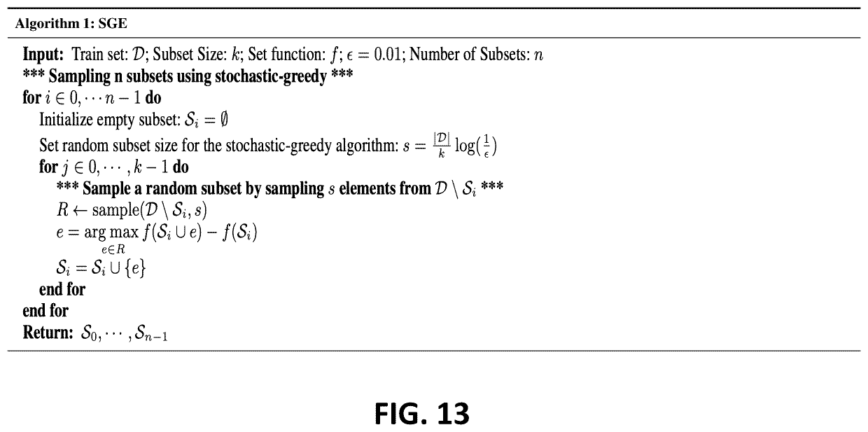

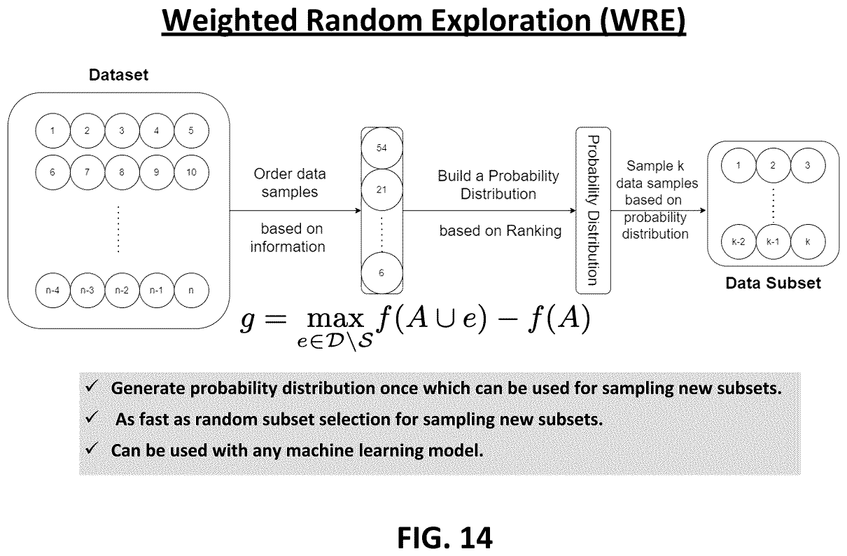

FIG. 5 depicts a simplified block diagram illustrating a non-limiting example of a system 500 in accordance with aspects of the invention. As shown, the system 500 includes a model-independent data subset selection (MIDSS) module 510 in electronic communication with a preprocessing module 506, a model training operations module 508, and a curriculum-based training & value assessment (CTVA) module 540, configured and arranged as shown. The model training operations module 508 is also in electronic communication with a model repository 530, and the preprocessing module 506 is also in electronic communication with a training data repository 520. In some embodiments of the invention, the preprocessing module 506 is optional. In some embodiments of the invention, the preprocessing module 506 and/or the CTVA module 540 are incorporated within the MIDSS module 510. In accordance with aspects of the invention, the MIDSS 510 and the optional preprocessing module 506 are operable to perform model-independent analysis of the various datasets (e.g., Dataset-1 522, Dataset-2 524, Dataset-3 526) stored in the training data repository 520 in order to select from those datasets data subsets that can be provided to the model training operations module 508 and used to efficiently train the various models (e.g., Model-1 532, Model-2 534, Model-3 536) stored in the model repository 530. In accordance with aspects of the invention, the MIDSS 510 is operable to perform the model-independent analysis of the various datasets using, inter alia, a data characteristic sampling module 511 configured to perform sampling operations that are based on analysis of the characteristics of the data that makes up the dataset itself. The data characteristic sampling module 511 includes model-independent sampling functionality 512, along with probability distribution sampling functionality 514. Model-independent sampling functionality 512 means that a dataset-under-analysis (e.g., Dataset-1 522) is sampled in a manner that is based on characteristics of the dataset-under-analysis and not based on specific features of a model the selected data subset will train. The probability distribution functionality (or probability distribution sampling functionality) 514 probabilistically samples from the dataset-under-analysis subsets of a given size with a bias towards higher values of certain data set quality measures. Non-limiting examples of suitable probability distribution functionality 514 include, but are not limited to, “stochastic greedy exploration” techniques (shown in FIGS. 12 and 13) and “weighted random exploration” techniques (shown in FIG. 14). The MIDSS 510 also works in tandem with the CTVA module 540 to monitor the model training operations module 508 to monitor training of the models (e.g., Model-1 532, Model-2 534, Model-3 536) using the selected data subsets operable to improve the efficiency and effectiveness of training operations without expending the computing resources and time that would be required to train using the full contents of the datasets (Dataset-1 522, Dataset-2 524, Dataset-3 526) in the training data repository 520. Additional details of the operations of the MIDSS module 510, the preprocessing module 506, and the CTVA module 540 are illustrated in FIGS. 6-14 and described in greater detail subsequently herein.

The components/modules of the system 500 are depicted separately for ease of illustration and explanation. In embodiments of the invention, the functions performed by the components/modules of the system 500 can be distributed differently than shown without departing from the scope of the embodiments of the invention describe herein unless it is specifically stated otherwise. For example, the model-independent functionality 512 and the probability distribution functionality 514 can be implemented as a single module. Additionally, functionality of the preprocessing module 506 and/or the CTVA module 540 can be incorporated within the MIDSS module 510.

For ease of illustration, only three (3) datasets are shown in the training data repository 520. It should be noted that any number of datasets can be used in accordance with aspects of the invention. Embodiments of the invention use novel selective probability distribution sampling/functionality (e.g., probability distribution functionality 514 shown in FIG. 5) to enable a relatively large number of datasets to participate in efficiently and effectively training models without having to expend the computing resources and time to train on each data point/record in each of the relatively large number datasets. Similarly, for ease of illustration, only three (3) models are shown in the model repository 530. It should be noted that any number of models can be used in accordance with aspects of the invention. Embodiments of the invention use novel selective probability distribution sampling/functionality (e.g., probability distribution functionality 514 shown in FIG. 5) to enable a relatively large number of models to be efficiently and effectively trained without having to expend the computing resources and time to train each model on each data point/record in each available of dataset.

FIG. 6 depicts a simplified block diagram illustrating a non-limiting example of a system 600 in accordance with aspects of the invention. As shown, the system 600 includes a model-independent run-once preprocessing (MROP) module 506A in electronic communication with a subset selector module 620, which is in communication with a model training module 508. In accordance with embodiments of the invention, the MROP module 506A includes pre-trained deep learning transformers 612. In accordance with embodiments of the invention, the transformers 612 can be implemented using the features and functionality of the transformer NN architecture 400 (shown in FIGS. 4A, 4B and 4C), as well as the embedding techniques depicted in FIG. 3.

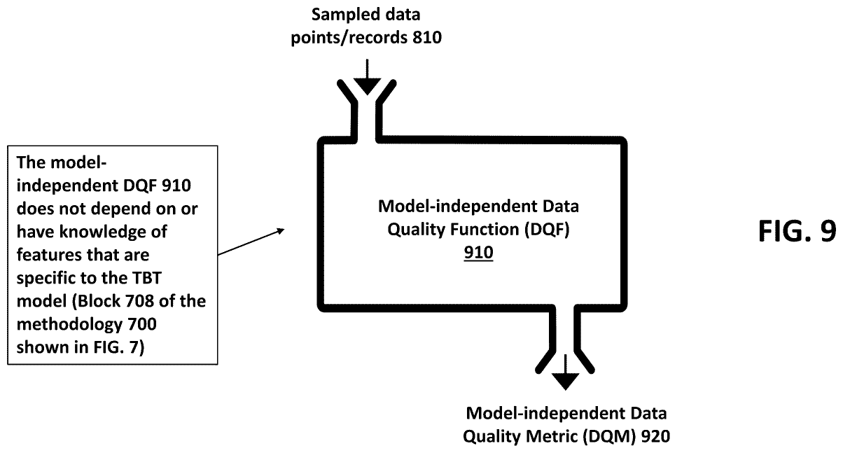

The MROP module 506A receives the Dataset-1 522 from the training data repository 520, and performs various operations to generate preprocessed Dataset-1 522A, which is passed to the subset selector 620. In general, the operations performed by the MROP module 506A analyze and organize the Dataset-1 522 into various instances of preprocessed Dataset-1 522A, which represents the Dataset-1 522 after analysis operations that organize the dataset into data structures that facilitate the subset selection operations performed by the subset selector 620. In this way, the data structures of the preprocessed Dataset-1 522A can be considered matched to functions (e.g., the model-independent data quality function (DQF) 910 shown in FIG. 9) of the subset selector 620 that map the preprocessed Dataset-1 522A and/or the Dataset-1 522 to data quality metrics (e.g., the model-independent data quality metrics (DQM) 920).

The subset selector module 620 includes the MIDSS module 510 and the CTVA module 540, configured and arranged as shown. An automated artificial intelligence (Auto AI) module 630 is in electronic communication with the system 600 through the model training module 508. In embodiments of the invention, the Auto AI module 630 can be implemented using an “AutoAI” tool in Watson Studio® that is commercially available from IBM®. The IBM AutoAI tool automatically analyzes data and generates candidate model pipelines customized for predictive modeling problem. These model pipelines are created iteratively as AutoAI analyzes dataset and discovers data transformations, algorithms, and parameter settings that work best for the problem setting. Results are displayed on a leaderboard, showing the automatically generated model pipelines ranked according to the problem optimization objective. In accordance with aspects of the invention, the subset selector 620 and other features of embodiments of the invention can be used to generate efficient and effective training data subsets that are used to improve the efficiency and effectiveness of the model evaluation and selection features of the Auto AI module 630.

Similar to system 500 shown in FIG. 5, the components/modules of the system 600 shown in FIG. 6 are depicted separately for ease of illustration and explanation. In embodiments of the invention, the functions performed by the components/modules of the system 600 can be distributed differently than shown without departing from the scope of the various embodiments of the invention describe herein unless it is specifically stated otherwise. For example, in some embodiments of the invention, the functionality of the MROP module 506A can be incorporated within the subset selector 620. In some embodiments of the invention, the functionality of the MROP module 506A can be incorporated within the MIDSS module 510 of the subset selector 620.

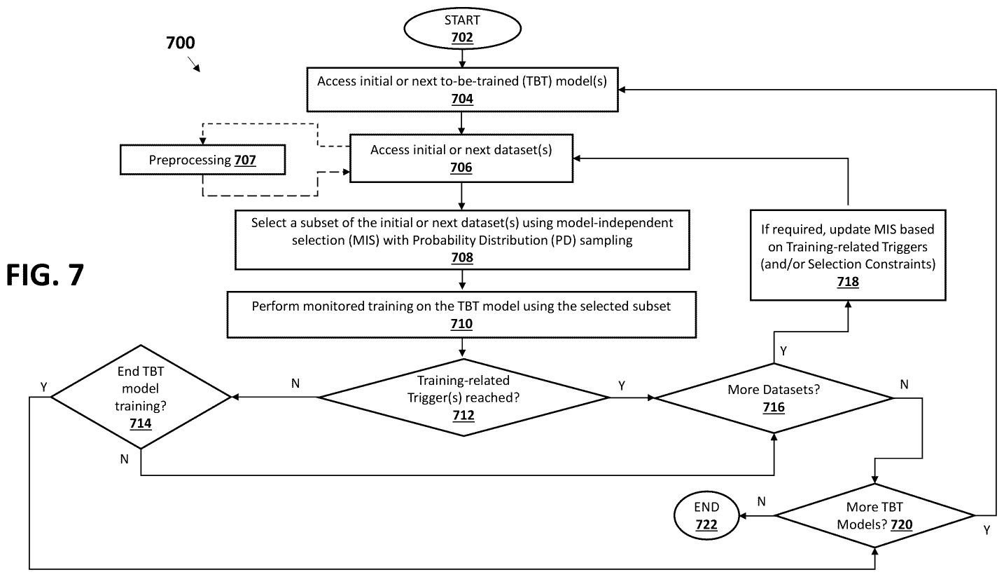

At the stage shown in FIG. 6, the system 600 has selected Dataset-1 522 and provided it to the MROP module 506A; and the system 600 has selected Model-1 532 and provided it to the model training operations module 508. In some embodiments of the invention, the system 600 is operable to process and analyze multiple datasets (e.g., Dataset-1 522 and Dataset-2 524) and/or multiple models (e.g., Model-1 532 and Model-2 534) substantially concurrently. Operations described herein as being applied to a single dataset and/or model can also be applied substantially concurrently to multiple datasets and/or multiple models. The system 600 uses the MROP module 506A and the subset selector 620 to analyze some or all of the data points/records of Dataset-1 522 in accordance with aspects of the invention to generate therefrom one or more model-independent data subsets (or sample subsets) 522B that can be used by the model training operations module 508 to efficiently and effectively train Model-1 532. Additional details of the operations of the systems 500, 600 (shown in FIGS. 5 and 6) are illustrated by the methodology 700 shown in FIG. 7 and will be described in greater detail in connection with the following description of FIG. 7.

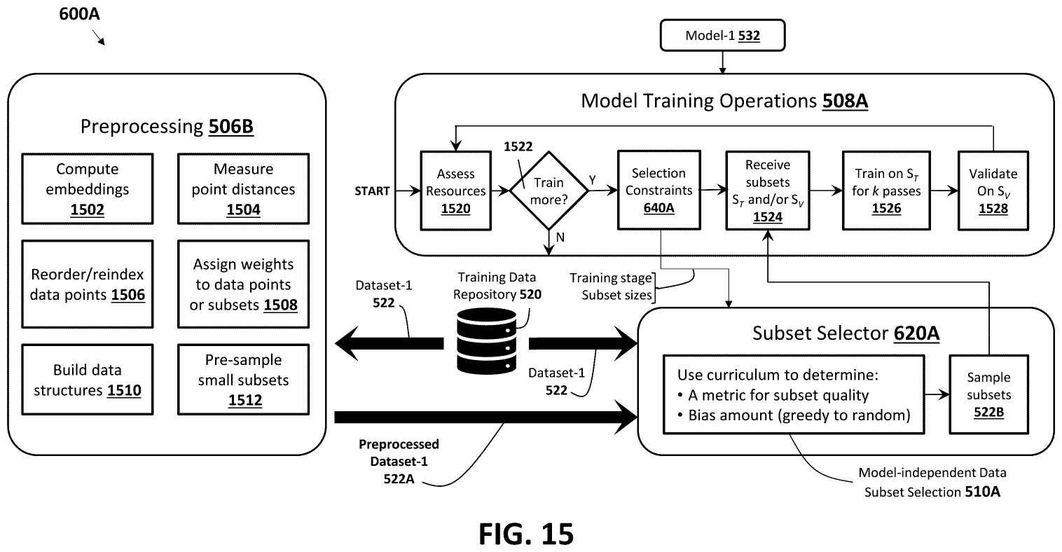

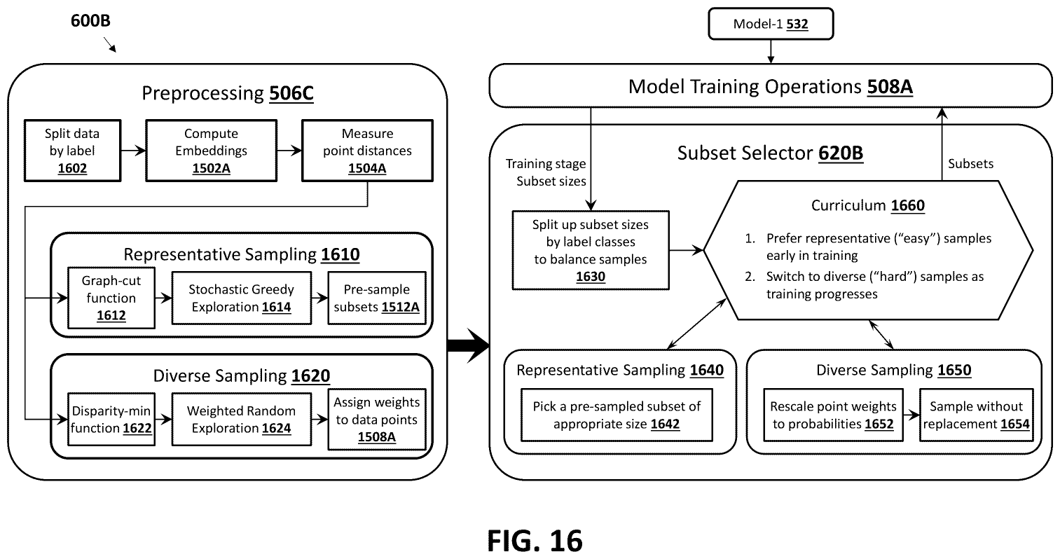

FIG. 7 depicts a flow diagram illustrating a computer-implemented methodology 700 according to embodiments of the invention. The computer-implemented methodology 700 is implemented by the systems 500, 600 shown in FIGS. 5 and 6 in the course of carrying out the efficient and effective selection of suitable data subset(s) of the Dataset-1 522 that can be used to efficiently and effectively train Model-1 532. The computer-implemented methodology 700 can also be implemented by the systems 600A, 600B shown in FIGS. 15 and 16 in the course of carrying out the efficient and effective selection of suitable data subset(s) of the Dataset-1 522 that can be used to efficiently and effectively train Model-1 532. In accordance with aspects of the invention, the data subset(s) are selected in a model-independent manner that uses probability distribution functionality to analyze model-independent data quality features of the data.

The methodology 700 begins at block 702 by initiating a new data subset selection/analysis session. At block 704, the methodology 700 uses the model training operations module 508 to access an initial or next to-be-trained (TBT) model (e.g., access Model-1 532 from the model repository 530). At block 706, the methodology 700 uses any of the preprocessing module 506, 506A, 506B, 506C to access an initial or next dataset (e.g., access Dataset-1 522 from the training data repository 520). At block 707, optional preprocessing operations are performed on the initial or next dataset to prepare the initial or next dataset for subset selection operations performed at block 708. In some aspects of the invention, the preprocessing operations at block 707 are performed once during an initial iteration of the operations at blocks 706, 708, 710, 712, 714, 716 and 718; and the preprocessing operations at block 707 are not performed during subsequent iterations of the operations at blocks 706, 708, 710, 712, 714, 716 and 718. In accordance with some aspects of the invention, the preprocessing module 506, 506A moves much of the subset selection computations performed at block 708 to the preprocessing operations performed at block 707 and shares the subset computations (e.g., subset data quality computations) across all of the TBT models that will be processed using the methodology 700. The computations moved to the preprocessing operations of block 707 are model-independent computations that would be the same regardless of the details of the TBT model. The preprocessing module 506, 506A initializes subset sampling methods for all data quality measures on the provided initial or next dataset (e.g., Dataset-1 522). In particular, and in accordance with aspects of the invention, the preprocessing module 506, 506A applies the pretrained deep-learning transformers 612 to compute vector embeddings for each data point of the initial or next dataset (e.g., Dataset-1 522).

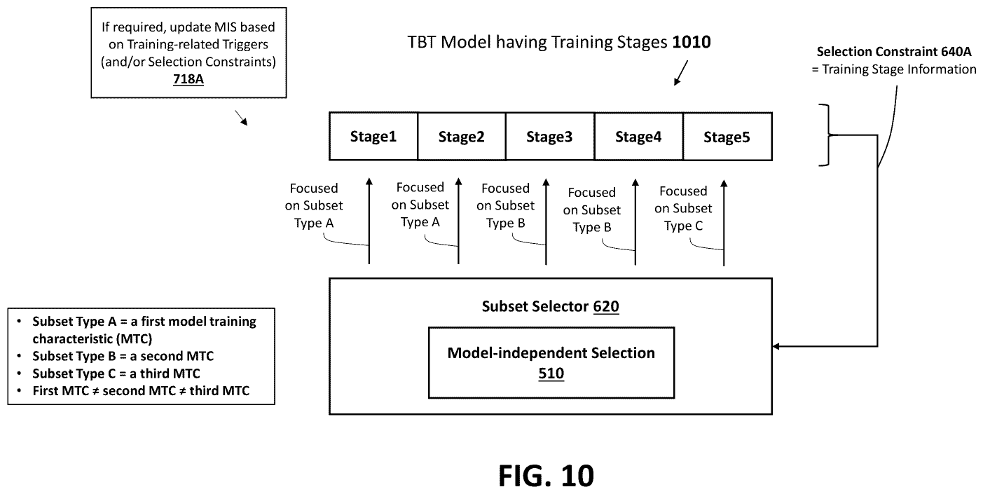

At block 708, the methodology 700 uses the subset selector 620, which uses the MIDSS 510 and the CTVA module 540, to select a subset of the initial or next dataset (e.g., Dataset-1 522) by implementing a model-independent selection (MIS) technique that uses the probability distribution functionality 514 (shown in FIG. 5). In some embodiments of the invention, the data selection constraints 640 (shown in FIG. 6) are provided to the subset selector 620 and taken into account when performing operations of the subset selector 620. In some embodiments of the invention, the processor resources (not shown separately) of the systems 500, 600 generate the data selection constraints 640. In some embodiments of the invention the data selection constraints 640 can include training stage information (generated by the model training operations module 508) and/or data subset size targets. FIG. 10 illustrates additional details of the data selection constraints 640 implemented as selection constraints 640A, which are implemented as training stage information. The data subset size targets provide a target size of the data subset selected by the subset selector 620. Additional details of how the data subset size targets can be utilized by the subset selector 620 are illustrated by the subset selectors 620A, 620B shown in FIGS. 15 and 16 and described in greater detail subsequently herein.

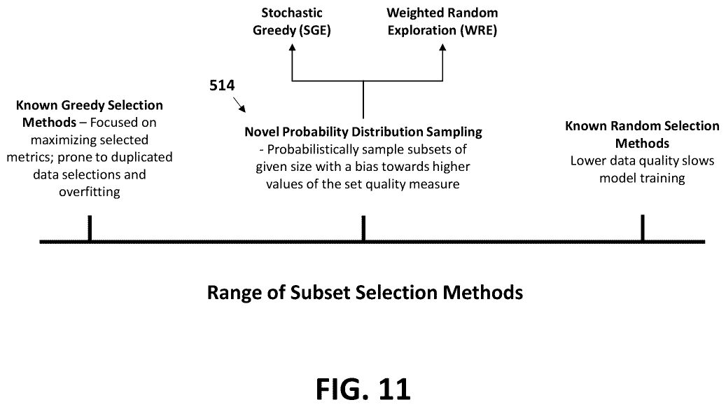

Returning to block 708, some or all of the probability distribution functionality 514 at block 708 can be performed using transformers, including, for example, the transformers 612 of the MROP module 506A. The probability distribution functionality 514 is utilized in generating various categories of data quality metrics of the initial or next dataset in order to extract from the initial or next dataset a data subset that can be used by the model training operations module 508 to perform model training. As shown in FIG. 11, the probability distribution functionality 514 bridges the gap between known purely “random” and known “greedy” methods of data subset selection. In accordance with embodiments of the invention, the probability distribution functionality 514 probabilistically samples data subsets of given size with a bias towards higher values of the set quality measure (i.e., the data quality metric). In embodiments of the invention, the probability distribution functionality 514 speeds up warm start training and mitigates overfitting. In some embodiments of the invention the probability distribution functionality 514 can be implemented using a stochastic greedy (SGE) approach (shown in FIG. 12 and FIG. 13) and/or a weighted random exploration (WRE) technique (shown in FIG. 14). The SGE maximizes set function with a stochastic greedy algorithm (e.g., as shown in FIG. 11-13) and different random seeds. The WRE selects data points one-by-one to maximize the gain in the data quality metric, then runs greedy maximizations and maps the set quality gain at each point's inclusion to its probability.

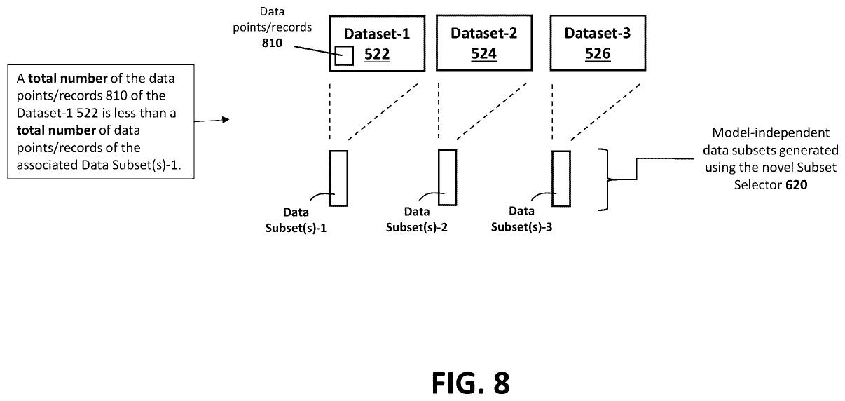

In aspects of the invention, the data quality metrics generated using the probability distribution functionality 514 can include, for example, diverse-data metrics, representative-data metrics, and/or coverage metrics, each of which identifies that the data subset associated with the particular type of data quality metric has a different effect on model training outcomes when the data subset associated with the particular type of data quality metric is used to train a model (any type of model). In this detailed description, the expected effect on model training outcomes of a data subset associated with the particular type of data quality metric is referred to as a model-training characteristic (MTC) of the data subset and/or the associated data quality metric. Representation metrics identify how well the data points/records (e.g., data points/records 810 shown in FIG. 8) in the subset (e.g., Data Subset(s)-1 shown in FIG. 8) represent the entire dataset's distribution, which favors the selection of samples from denser regions that tend to have “easier” (i.e., more typical) data samples that are more easily learned by models that are undergoing model training. It should be noted that, as shown in FIG. 8, a total number of the data points/records 810 of the Dataset-1 522 is less than a total number of data points/records of the associated Data Subset(s)-1. Diverse metrics identify how different the sampled data points/records in the data subset are from each other, which favors the probability distribution functionality 514 selecting very different samples which means the subset will contain very different samples, and such data subsets tend to have “harder” (e.g., more outlier) data samples that are more difficult to learn by a model that is undergoing model training. For small data subset sizes, or in earlier training stages, representative set functions tend to result in a steeper accuracy rise; and for larger data subset sizes, or in later training stages, diverse dataset functions tend to result in a better performing model. Coverage metrics measure how close the data subset is to each dataset point or cluster, which encourages data subsets to have samples from all kinds of data. In the examples described above, the MTC of the representative/diversity/coverage metric is how easily the model learns from the associated data samples during model training. In some embodiments of the invention, how easily a model learns from data samples during various stages of model training is based on a projection of how long (or how fast) it takes to complete model training on data samples having a given type of data quality metrics. This projection of how long (or how fast) it takes to complete model training is represented by a range of expected model training speeds associated with a given representative/diversity/coverage metric, where the ranges of expected model training speeds associated with representative/diversity/coverage metrics are different from one another.

FIG. 9 depicts another example of how the operations at block 708 of the methodology 700 can be implemented in accordance with aspects of the invention. Block 708 executes a model-independent selection (MIS) algorithm having, inter alia, probability distribution functionality 514 operable to select a first data subset from a first dataset based at least in part on using the probability distribution functionality 514 to generate one or more data quality metrics. The one or more data quality metrics include a first data quality metric (e.g., a model-independent data quality metric (DQM) 920) that results from using a first function (e.g., a model-independent data quality function (DQF) 910 to map first data points (e.g., sampled data points/records 810) of the first dataset to the first data quality metric. In embodiments of the invention, the model-independent DQF 910 can be implemented using, inter alia, the probability distribution functionality 514. In embodiments of the invention, the model-independent DQM 920 can be implemented as the various types of data quality metrics (e.g., a diverse-data metric, a representation-related metric, a coverage metric, and the like). The first function is independent of a type of the TBT model. The first data subset is provided to the TBT model.

Returning to the methodology 700 shown in FIG. 7, subsequent to the operations at block 708, one or more data subsets (e.g., Data Subset(s)-1 shown in FIG. 8) of the initial or next dataset (e.g., Dataset-1 522 shown in FIG. 8) have been selected using the MIS techniques described above. In embodiments of the invention, block 708 can identify multiple data subsets, substantially concurrently, from a given dataset (e.g., Dataset-1 522); and block 708 can select data subsets for multiples datasets (e.g., Dataset-1 522 and Dataset-2 524) substantially concurrently. The methodology 700 moves to block 710 and uses the model training operations module 508 to train the TBT model using the data subset(s) generated or selected at block 708. In accordance with aspects of the invention, the training operations performed at block 710 are performed in a “training-related monitoring” fashion, which means that the systems 500, 500A, 600, 600A gather various training-related information related to or associated with various aspects of the training operations performed at block 710 that will be used to improve the overall effectiveness and efficiency of the methodology 700. In some embodiments of the invention, the training-related information related to or associated with various aspects of the training operations performed at block 710 include but are not limited to the operations at blocks 1520, 1522, 640A of the model training operations module 508A (shown in FIG. 15). In embodiments of the invention, the monitored data subset training that occurs at the model training module 508 is referred to herein as a “curriculum-based” learning in which the cumulative nature of the training operations performed by the model training operations module 508 is used to make various adjustments to the methodology 700, including, for example, varying the data subset size and taking into account the MTCs of the various selected datasets as model training progresses-a form of curriculum learning. The adjustments to the methodology 700 based on the training-related information can further include sampling “easy” representative subsets early in training, then “hard” diverse subsets later in training, choosing their size to fit within a predetermined time limit. The adjustments to the methodology 700 based on the training-related information can further include scheduling the application of each data subset based on the data subset size, the model training stage, and the remaining resources of the systems 500, 600 that can be devoted to training. The adjustments to the methodology 700 based on the training-related information can further include attaching different weights to the data quality metrics of the selected datasets, including but not limited to a diverse-data metrics, representation-related metrics, and/or coverage-based metrics.

The above-described curriculum-based learning and associated adjustments to the methodology 700 are illustrated by the training stages 1010 depicted in FIG. 10. More specifically, FIG. 10 illustrates how the subset selector 620 is adjusted based on “training-related monitoring” of training operation performed at block 710 using the training operations module 508. The subset selector 620 performs the operations at block 708 to select the data subsets in accordance with aspects of the invention and provide the selected data subsets to the model training operations module 508. The subset selector module 620 uses, inter alia, the probability distribution functionality 514 (shown in FIG. 5) to generate and utilize multiple model-independent data quality metrics for determining the quality of a selected subset independently of the specific details of the TBT model the selected subset will be used to train. Data subset quality can be represented as the data subset's MTC as represented by the data subset's data quality metric(s). In some embodiments of the invention, the MTC for a given type of subset (e.g., Subset Type A shown in FIG. 10), where the Subset Type can be represented by the subset's data quality metric(s), can be comparative training speed expected at various training stages 1010. As shown, Subset Type A can have a first MTC; Subset Type B can have a second MTC; and Subset Type C can have a third MTC. The first MTC, the second MTC, and the third MTC can be different from one another. The model training operations performed at block 710 can generate training-related triggers in the form of selection constraints 640, 640A. As shown in FIG. 10, the selection constraints 640A can be training stage information identifying whether the training stage 1010 is Stage 1 (earliest), Stage2, Stage3, Stage4, or Stage5 (latest). The subset selector 620 can use the selection constraint 640A and the MTC information to determine whether or not the focus of the selected data subset(s) provided to the model training operations module 508 will be Subset Type A, Subset Type B, or Subset Type C. Assuming all three subset types are available at each training stage, at Stage1, the subsets provided to the model training operations module 508 can focus on Subset Type A because at Stage1, learning quality (e.g., learning speed) is highest for Subset Type A having the first MTC. The term “focus” can refer to prioritizing one Subset Type over other available Subset Types. The “prioritizing” can be time-based in that the prioritized Subset Type happens early in the training process. The “prioritizing” can be weight-based in that the prioritized Subset Type has a higher weight than other Subset Types in the training process. At Stage2, the subsets provided to the model training operations module 508 can still focus on Subset Type A because at Stage2, learning quality (e.g., learning speed) is still expected to be highest for Subset Type A having the first MTC. At Stage3, the subsets provided to the model training operations module 508 can shift to focus on Subset Type B because at Stage3, learning quality (e.g., learning speed) is expected to be highest for Subset Type B having the second MTC. At Stage4, the subsets provided to the model training operations module 508 can still focus on Subset Type B because at Stage4, learning quality (e.g., learning speed) is still expected to be highest for Subset Type B having the second MTC. At Stage5, the subsets provided to the model training operations module 508 can shift to focus on Subset Type C because at Stage5, learning quality (e.g., learning speed) is expected to be highest for Subset Type C having the third MTC.

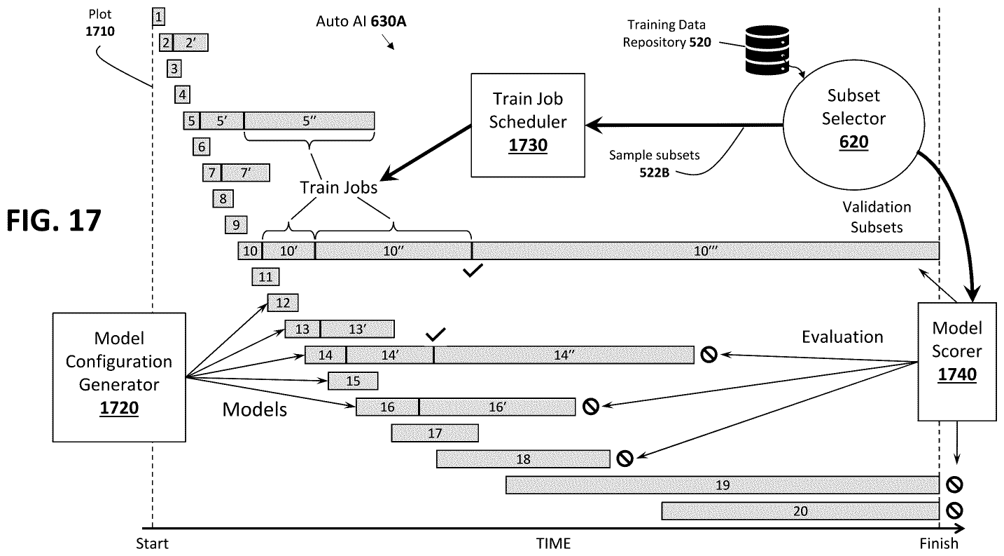

Returning to FIG. 7, the above-described “training-related monitoring” is referred to in the methodology 700 as “training-related triggers,” and, at decision block 712, the methodology 700 evaluates whether the training operations at block 710 generated training-related triggers. If no training-related triggers were generated, no changes to the MIS are needed, and the methodology 700 moves to decision block 714 to determine whether or not training of the TBT model accessed at block 704 and trained at block 710 should be ended or postponed. Decision block 714 can be implemented using the Auto AI module or system 630, 630A (shown in FIGS. 6 and 17), which uses the evaluations performed by the methodology 700 to determine whether or not the TBT model is training in a manner that suggests that the Auto AI 630, 630A should end/suspend training (Yes) or perform additional training (No). If the answer to the inquiry at decision block 714 is yes, the methodology 700 moves to decision block 720 to determine whether or not there are more TBT models (i.e., more models in the model repository 530). If the answer to the inquiry at decision block 720 is no, the methodology 700 moves to block 722 and ends. If the answer to the inquiry at decision block 720 is yes, the methodology 700 returns to block 704 and performs another iteration of the methodology 700 on the next TBT model. If the answer to the inquiry at decision block 714 is no, the methodology 700 moves to decision block 716 to determine whether or not there are more datasets (i.e., more datasets in the training data repository 520). If the answer to the inquiry at decision block 716 is yes, the methodology 700 moves to block 718 and updates the MIS based on the training-related triggers, if required (e.g., as shown at block 718A in FIG. 10). The methodology 700 moves from block 718 to block 706 to access an initial or next dataset and perform another iteration of methodology 700. If the answer to the inquiry at decision block 716 is no, the methodology 700 moves to decision block 720 to determine whether or not there are more TBT models (i.e., more models in the model repository 530). If the answer to the inquiry at decision block 720 is no, the methodology 700 moves to block 722 and ends. If the answer to the inquiry at decision block 720 is yes, the methodology 700 returns to block 704 and performs another iteration of the methodology 700 on the next TBT model.

FIG. 15 depicts a simplified block diagram illustrating a non-limiting example of a system 600A in accordance with aspects of the invention. The system 600A provides substantially the same features and functionality as the system 600 (shown in FIG. 6), however, the system 600A provides additional details of how features and functionality of the system 600 can be implemented in accordance with some aspects of the invention. As shown in FIG. 15, the system 600A includes a preprocessing module 506B in electronic communication with the training data repository 520 and a subset selector 620A, which is in electronic communication with the training data repository 520 and a model training operations module 508A. In accordance with aspects of the invention, the features and functionality of the preprocessing module 506B can be implemented using, for example, the pre-trained deep learning transformers 612 (shown in FIG. 6). In accordance with embodiments of the invention, the transformers 612 can be implemented using the features and functionality of the transformer NN architecture 400 (shown in FIGS. 4A, 4B and 4C), as well as the embedding techniques depicted in FIG. 3.

The preprocessing module 506B receives the Dataset-1 522 from the training data repository 520, and performs various operations to generate preprocessed Dataset-1 522A, which is passed to the subset selector 620A. In general, the operations performed by the preprocessing module 506B analyze and organize the Dataset-1 522 into various instances of preprocessed Dataset-1 522A, which represents the Dataset-1 522 after analysis operations that organize the dataset into data structures that facilitate the subset selection operations performed by the subset selector 620A. In this way, the data structures of the preprocessed Dataset-1 522A can be considered matched to functions (e.g., the model-independent DQF 910 shown in FIG. 9) of the subset selector 620A that map the preprocessed Dataset-1 522A and/or the Dataset-1 522 to data quality metrics (e.g., the model-independent DQM 920).

In accordance with embodiments of the invention, the preprocessing module 506B can include, in any combination, a compute embeddings module 1502, a measure point distances module 1504, a reorder/reindex data points module 1506, an assign weights to data points or subsets module 1508, a build data structures module 1510, and a pre-sample small subsets module 1512, configured and arranged as shown. The computer embeddings module 1502 is operable to computing embeddings from the Dataset-1 522 (e.g., using the features and functionality of the transformer NN architecture 400 depicted in FIGS. 4A, 4B and 4C, as well as the embedding techniques depicted in FIG. 3). In embeddings, a transformer-based NN model is invoked to map data records (e.g., data points/records 810 shown in FIG. 8) into real number vectors. The measure point distances module 1504 can take these real number vectors and, using any one of a variety of suitable techniques, measure distances between pairs of real number vectors, thereby generating pairwise distances that enable the identification of data points/records that are close together, as well as the identification data points/records that are far away from one another.

The reorder/reindex module 1506 uses any one of a variety of suitable reordering/indexing techniques to reorder and reindex the real number vectors so that the real number vectors can be easily sampled. For example, the real number vectors can be organized based on the amount of gain (e.g., highest gain to the lowest gain) its corresponding data point/record adds to a given model-independent DQM (e.g., model-independent DQM 920) after a model-independent DQF (e.g., model-independent DQF 910) has been applied to the real number vectors (e.g., a subset of the real number vectors). In general, the gain of a data point p is the difference F(S∪{p})−F(S) where S is the subset before point p has been added. That is, the gain is how much p adds to the quality of subset S. As another example, if the relevant data points/records have labels, a priority of the subset selector 620A can be to make sure that the sample subsets 522B selected by the subset selector 620 have suitable (e.g., proportional) representation from all of the labels in the Dataset-1 522. Labeled data points/records can be partitioned into subsets for each label class, and data points/records with the same label class can be grouped together. At the module 1508, weights are assigned to data points/records in order to subsequently perform probabilistic selection (e.g., probability distribution functionality 514 shown in FIG. 5). The added weights can correspond to and/or represent the previously described gains provided by the real number vectors. That weights added at module 1508 can be useful to the probabilistic sampling operations of the subset selector 620A in that data points/records with larger gain have higher weight. With weights assigned, module 1510 builds various data structures (e.g., tree data structures) in order to index data points/records more efficiently. Module 1512 allows small subsets to be pre-sampled. The small pre-sampled subsets improve subset selection operations of the subset selector 620A by functioning as pre-selected subsets that just need to be confirmed by the subset selector 620A rather than being selected from scratch.

The various data structures generated by the modules 1502, 1504, 1506, 1508, 1510, 1512 of the preprocessing module 506B are included in the preprocessed Dataset-1 522A and have the general impact of improving the speed and efficiency of subset selection operations performed by the subset selector 620A. The preprocessed Dataset-1 522A includes embeddings; pair-wise distances between data points/records; any reordering or indexing performed to make it more efficient to sample data points/records or to make sure that each label class is represented in a fair manner in the sample subsets 522B; and any pre-sampled subsets 1512. Weights associated with data points/records (module 1508) are also included in the preprocessed Dataset-1 522A and made available to the subset selector 620A so that the subset selector 620A can compute probabilities to select a given data point/record for inclusion in the selected data subset.

The subset selector 620A receives the preprocessed Dataset-1 522A from the preprocessing module 506B; the Dataset-1 522 from the training data repository 520; and selection constraints (e.g., training stage information and subset size information) from the selection constraints module 640 of the model training operations module 508A. The subset selector 620A is configured and arranged to include a model-independent data subset selection operation 510A operable to generate sample subsets 522B in accordance with aspects of the invention and provide the same to the model training operations module 508A. The subset selector module 620A generates multiple model-independent metrics for determining the quality of a subset independently of the specific details of the model the subset will be used to train. In some embodiments of the invention, the model-independent data subset selection operations 510A consider two types of data quality metrics, namely representativity metrics and diversity metrics. Representativity metrics measure how well the distribution of points in the subset mimics the distribution of points in the overall data set, and the diversity metric tests how far apart points are in the subset in order to avoid near duplicates of data points/records in the selected subset. Because representative subsets are generally easier to train models on, in some embodiments of the invention, the model-independent data subset selection module 510A focuses on training with the representativity portions of the subsets early in the training operations (e.g., Stage1 or Stage2 shown in FIG. 10). Because diverse subsets are generally harder to train models on, in some embodiments of the invention, the model-independent data subset selection module 510A focuses on training with the diverse portions of the subsets later in the training operations (e.g., Stage4 and/or Stage5 shown in FIG. 10).

The model training operations module 508A includes an assess resources module 1520, a “train more” decision module 1522, a selections constraint module 640A, a receive subsets module 1524; a training module 1526, and a validation module 1528, configured and arranged as shown. The operations performed by the model training operations module 508A to generate the outputs from the selection constraints module 640A will now be described. A first iteration of the model training operations module 508A starts at the assess resources module 1520. At this stage, the Model-1 532 has been selected from the model repository 530 and made available to be trained under control of the model training operations module 508A. In some embodiments of the invention, multiple models (e.g., both Model-1 532 and Model-1 534) are processed in parallel by the model training operations module 50A. In some embodiments of the invention, an initial set of models is selected for initial rounds of training, and then additional models are added and/or subtracted as training proceeds. The assess resources module 1520 performs operations that assess the processing resources that are available to perform the training operations of the of the model training operations module 508A, as well as assessments of the quality of training operations or training stages (e.g., Stage1, Stage2, Stage3, Stage4, and Stage5 shown in FIG. 10). In some embodiments of the invention, the system 600, 600A, and more specifically, the subset selector 620, 620A, 620B (shown in FIG. 16) are incorporated within an AutoAI system 630A shown in FIG. 17. Where the system 600, 600A is incorporated within the AutoAI system 630A, the assess resources module 1520 accesses the various functionality of the AutoAI system 630A to assess resources, schedule training operations, and assess the quality of training operations at the various training stages (e.g., as represented by the Training Stages shown in FIG. 10). Additional details of the operations of the AutoAI system 630A are described in greater detail subsequently herein in connection with the description of FIG. 17.

Subsequent to the assess resources module 1520, the decision module 1522 determines whether or not more training should be done. During the first iteration of the model training operations module 508A, the subset selector 620A has not yet received outputs from the selection constraints module 640A, so has not yet generated an output from its sample subsets (or sample subsets module) 522B. Accordingly, during the initial iteration of the model training operations module 508A, if enough resources are provided to begin training this model, the answer to the inquiry at decision module 1522 is yes, and the model training operations module 508A moves to selection constraints module 640A to generate, based at least in part on the operations at the assess resources module 1520, selection constraints. In the illustrated embodiments of the invention, the output of the selection constraints module 640A is the current training stage (e.g., Stage1 shown in FIG. 10) of the model training operations module 508A, as well as the target size limit of the subset that will be selected by the subset selector 620A.

At this stage of the operations performed by the model training operations module 508A, the subset selector 620A has received the preprocessed Dataset-1 522A, the Dataset-1 522, and the selection constraints (e.g., training stage and subset size), which can now be used to perform the model-independent data subset selection 510A, thereby generating the sample subsets 522B and providing the same to module 1524 of the model training operations module 508A. The model-independent data subset selection module 510A can be implemented to perform model-independent data selection operations using the same features and functionality as the model-independent data subset selector 510 (shown in FIGS. 5 and 6), as well as the features and functionality of the MIS operations performed at block 708 of the methodology 700 (shown in FIG. 7). Additional details of how the subset selector 620A can be implemented are depicted by subset selector 620B shown in FIG. 16 and described subsequently herein.

In embodiments of the invention, the sample subsets 522B can be training samples ST or validation samples Sv or both. In some embodiments of the invention, methods other than the subset selector 620A can be used to select data that will be used as Sv. At block 1524 of the model training operations module 508A, ST and/or Sv are received and used at blocks 1526 and 1528 to train and validate Model-1 532 using any suitable training and validation methodology. This completes an initial iteration of the operations performed by the model training operations module 508A. In a next iteration of the operations performed by the model training operations module 508A, the assess resources module 1520 makes another assessment of the resources available to do additional training, however, in this iteration, the resource assessment is made after a training stage (e.g., Stage 1 shown in FIG. 10) has completed. Thus, in the current iteration of the operations performed by the model training operations module 508A, the decision at decision module 1522 of whether to do additional training can be based on a number of criteria. For example, if the initial iteration allocated 10 milliseconds (ms) to the training and validation modules 1526, 1528, and the operations at the training and validation modules 1526, 1528 completed in 6 ms, there are 4 ms left, and decision module 1522 can determine that the additional 4 ms should be used for additional training. The evaluation at decision module 1522 can also take into account the quality of the training that has been completed. For example, if the 10 ms have been allocated to the training and validation modules 1526, 1528 for the current iteration, and the operations at the training and validation modules 1526, 1528 completed in 6 ms, there are 4 ms left, and decision module 1522 can determine that the additional 4 ms should be used for additional training but only if the quality of completed training/validation operations exceed a threshold.

If the result of the inquiry at decision module 1522 is no, training and/or validation operations on the Model-1 532 are discontinued as a determination has been made that the remaining 4 ms of training time is not sufficient to resume productive training for Model-1 532, and the resources of the model training operations module 508A continue with other models (e.g., Model-2 534 and/or Model-3 536 shown in FIG. 5). If the result of the inquiry at decision module 1522 is yes, training and/or validation operations on the Model-1 532 continue until the Model-1 532 is completely trained, or until a subsequent iteration determines at decision module 1522 that training should be discontinued as a determination has been made that training resources should no longer be allocated to training the Model-1 532. In some embodiments, after a determination has been made that training resources will no longer be allocated to training the Model-1 532, the Model-1 522 can be subsequently processed in several ways, including being discarded; have its training resumed later depending on its comparative performance versus the other models; and/or the model can be returned to the user as partially trained (if requested). In embodiments of the invention, the decision of how to deal with the Model-1 532 after training resource allocation has been terminated can be determined using an Auto AI algorithm (e.g., one or more components of the Auto AI 630A shown in FIG. 17).

FIG. 16 depicts a simplified block diagram illustrating a non-limiting example of a system 600B in accordance with aspects of the invention. The system 600B provides substantially the same features and functionality as the systems 600, 600A (shown in FIGS. 6 and 15), however, the system 600B provides additional details of how features and functionality of the preprocessing module 506B (shown in FIG. 15) can be implemented as a processing module 506C, as well as additional detail of how the features and functionality of the subset selector 620A (shown in FIG. 15) can be implemented as a subset selector 620B. Although the system 600B includes the same features and connectivity (e.g., connections to the training data repository 520) as the system 600A, for ease of illustration, only the preprocessing module 506C, the model training operations module 508A, and the subset selector module 620B are shown in FIG. 16. Although the model training operations module 508A is shown in simplified form in FIG. 16, the model training operations module 508A shown in FIG. 16 includes all of the features and functionality of modules 1520, 1522, 640A, 1524, 1526, 1528 depicted in FIG. 15. As shown in FIG. 16, the preprocessing module 506C includes a split data by label module 1602, a compute embeddings module 1502A, a measure point distances module 1504A, a representative sampling module 1610, and a diverse sampling module 1620, configured and arranged as shown. The representative sampling module 1610 includes a graph-cut function 1612, an SGE module 1614, and a pre-sample subsets module 1512A, configured and arranged as shown. The diverse sampling module 1620 includes a minimum disparity function module 1622, a WRE module 1624, and an assign weights to data points module 1508A, configured and arranged as shown.

In the preprocessing module 506C at the split data by label module 1602, data is split by labels to make sure that for each label class, a separate sampling procedure can be performed. For each label class, module 1502A computes embeddings of data points/records using, for example, transformer-based models. At module 1504A, the previously described distances between pairwise data points/records, and this information is provided in parallel to the representative sampling module 1610 and the diverse sampling module 1620. In the representative sampling module 1610, module 1612 applies a submodular function in the form of a graph-cut function 1612 as a subset quality metric, to bias probabilistic subset sampling towards higher representativity. In some embodiments of the invention, the submodular function can be a facility location function. Then, module 1614 runs a SGE algorithm (e.g., as shown in FIGS. 12 and 13). The SGE selects multiple subsets of high quality according to the submodular metric by repeatedly picking the maximum-gain element from random subsets of the dataset. Module 1512A then performs pre-sample subset analysis similar to module 1512 shown in FIG. 15. In the diverse sampling module 1620, a different data quality metric is used to measure diversity, which is, as an example, a minimum disparity function 1612. The minimum disparity function is used to increase disparity, not to minimize it. A goal of the minimum disparity function is to increase the minimum disparity. A WRE operation is performed (as shown in FIG. 14), and module 1508A assigns weights to data points/records. Thus, each data point/record is assigned a weight to measure how likely it is the point/record will be sampled in in a given subset of a given size without replacement. In some embodiments of the invention, instead of computing weights, module 1508A could instead compute a score, which can be mapped into a weight in subsequent processing/analysis.

The output of the representative sampling module 1610 and the output of the diverse sampling module 1620 are provided to the subset selector 620B. The subset selector 620B includes modules 1630, 1640, 1642, 1650, 1652, 1654, and 1660 configured and arranged as shown. Modules 1630, 1640, and 1650 feed information to module 1660, which generates the model-independent subset and provides the same to the model training operations module 508A. Module 1630 receives the selection constraints (e.g., selection constraints 640 shown in FIG. 6) from the model training operations module 508A. In the embodiments shown in FIG. 16, the selection constraints are training stage information and subset size information. Module 1630 splits up the subset sizes by label classes to balance samples. Module 1640 performs representative sampling operations by using module 1642 to pick a pre-sampled subset of appropriate size. Module 1650 performs diverse sampling by using module 1652 to rescale point weights to probabilities; and by using module 1654 to sample without replacement.

Module 1660 performs what are referred to herein as “curriculum” operations that consider two types of data quality metrics, namely representativity metrics from module 1640 and diversity metrics from module 1650. Representativity metrics measure how well the distribution of points in the subset mimics the distribution of points in the overall data set, and the diversity metric tests how far apart points are in the subset in order to avoid near duplicates of data points/records in the selected subset. Because representative subsets are generally easier to train models on, in some embodiments of the invention, the module 160 focuses on training with the representativity portions of the subsets early in the training operations (e.g., Stage1 or Stage2 shown in FIG. 10). Because diverse subsets are generally harder to train models on, in some embodiments of the invention, the module 1660 focuses on training with the diverse portions of the subsets later in the training operations (e.g., Stage4 and/or Stage5 shown in FIG. 10). In some embodiments of the invention, the curriculum operations performed by the module 1660 can consider additional types of data quality metrics, namely coverage metrics and/or hybrid metrics.

FIG. 17 depicts a plot 1710 that illustrates how a subset selector 620, 620A, 620B in accordance with embodiments of the invention can be incorporated within an AutoAI system to generate the Auto AI system 630A show in FIG. 17. The system 630 includes a model configuration generator 1720, a train job scheduler 1730, the subset selector 620, 620A, 620B, and a model scorer 1740, configured and arranged as shown. In embodiments of the invention, the Auto AI module 630A can be implemented using an AutoAI tool in Watson Studio® that is commercially available from IBM®. The IBM AutoAI tool automatically analyzes data and generates candidate model pipelines customized for predictive modeling problem. These model pipelines are created iteratively as AutoAI analyzes dataset and discovers data transformations, In accordance with aspects of the invention, the subset selector 620, 620A, 620B and other features of embodiments of the invention can be used to generate efficient and effective training data subsets that are used to improve the efficiency and effectiveness of the model evaluation and selection features of the Auto AI module 630A.

Accordingly, it can be seen from the foregoing detailed description that embodiments of the invention provide a method and a computer-implemented system for efficient training machine learning (ML) models on a provided dataset where each training iteration runs on a subset of this dataset sampled from a probability distribution guided by a subset quality measure. The system includes one or more subset quality measures. For each subset quality measure, a method to randomly sample subsets of given size with bias towards higher value of the quality measure. A schedule or curriculum is provided that determines subset size and the choice of subset quality measure for each training iteration. An iterative ML model training method is provided that includes sampling subsets of high quality measures, where their sampling probability distributions and sampling methods, instantiated for the provided dataset, do not depend on the state of the ML model being trained (are “model-independent”). This and other features enable the system to split its execution into the preprocessing steps and the model training step in the following manner. The preprocessing step performs the calculations required in order to initialize subset sampling methods for all models and all quality metrics on the provided dataset; and the model training step performs ML model training iterations on subsets sampled according to the schedule, until a termination criterion is satisfied.

In some embodiments of the invention, the above-described method and system is instantiated for the task of label prediction, wherein the system has the following inputs: a dataset of labeled data points, partitioned into a training dataset and a validation dataset; one or more ML models for label prediction, which can be untrained, pre-trained, or partially trained; a training module that performs one training pass for an ML model on a given subset of the training dataset; and an evaluation module that scores a partially trained ML model on the validation dataset.

The system outputs versions of the input ML models that were trained on subsets of the training dataset. The system includes the steps of preprocessing and model training. In the preprocessing step, for each of the subset quality measures, given the training dataset, embodiments of the invention output either a sequence of high-quality subsets or a module that can efficiently sample high-quality subsets. These subsets are randomly generated with bias towards higher quality measure given their size, independently of the ML models to be trained. In the model training step, for each ML model, we perform training passes according to a schedule until a termination criterion is satisfied. For each pass, the step does the following: checks if a termination criterion is satisfied, which can involve the number of passes, the amount of time, or/and the ML model's score attained on the validation dataset; chooses the subset quality measure and size for this pass according to a schedule; reads or generates a training subset for the chosen quality measure and size using the preprocessing output; and trains the ML model for one pass on this training subset using the training module.

In some embodiments of the invention, the above-described method and system includes, but are not limited to two kinds of subset quality measures, representation measures and diverse measures. For representation measures, given a subset of data points, they measure how well the subset represents the entire training dataset. For example, a higher quality measure may ensure that the subset contains more samples from dense regions than from sparse regions. Such subsets tend to have easier-to-learn data samples. Examples of subset quality measures for modeling representation include facility location and graph-cut set functions.

Diversity metrics, given a subset of data points, measure how different the data points in the subset are from each other. For example, a higher quality measure may ensure that the subset contains very different data samples. Such subsets tend to have harder-to-learn data samples. Examples of subset quality measures for modeling diverse data include the disparity-sum and disparity-min set functions. In this setting, the ML model training schedule first performs training passes on subsets generated for a representation measure (with easier-to-learn samples), then performs training passes on subsets generated for a diverse measure (with harder-to-learn samples).

In some embodiments of the invention, the above-described method and system includes, but are not limited to a method and a computer-implemented system to randomly sample subsets of given size from a provided dataset, so that its sampling probability distribution is biased towards higher values of a specified subset quality measure, yet allows for randomness, thus balancing data exploration and exploitation. To define the subset quality measure, each data point is mapped to a fixed-dimensional feature vector using a pre-trained transformer-based model as feature encoder. The choice of the transformer-based model depends on the type of the data; where examples include large language models for text data and pre-trained vision transformers for image data. For efficiency, the system splits its execution into the preprocessing step followed by the subset sampling step. The subset sampling step generates subset samples of requested sizes in response to requests for such subsets. The preprocessing step performs the calculations required in order to initialize subset sampling on the provided dataset, which includes mapping each data point to a fixed-dimensional feature vector using a pre-trained transformer-based model as feature encoder; computing or approximating the similarity kernel matrix over the feature vectors to facilitate the evaluation of the subset quality measure; optionally, pre-computing some sampled subsets and/or weights of data points and/or data structures to quickly sample subsets.

In some embodiments of the invention, the above-described method and system includes, wherein the subset selection method uses SGE over a representation-type subset quality measure that must be a submodular set function (such as graph cut function), and includes the following steps: input the dataset, the representation-type subset quality measure, the number n of subsets, and the size of each subset; compute the feature vectors and the kernel matrix as described above; employ the stochastic greedy algorithm (FIG. 13) for maximization of the subset quality function and repeat the maximization n times with different random seeds; and output n subsets S_1, S_2, . . . , S_n.

In some embodiments of the invention, the above-described method and system includes, wherein the subset selection method uses WRE over a diverse-type subset quality measure (such as disparity-min) that does not have to be submodular, and includes the following steps: run the greedy algorithm that selects subset data points one-by-one from the training dataset to maximize the subset quality measure at every step; for each selected data point, store the quality measure gain at the moment of that point's greedy inclusion as its importance score; normalize the importance scores and construct a multinomial probability distribution over the training dataset by employing the second order Taylor Softmax function over the importance scores; and use a weighted random sampling approach to sample from this distribution a subset of given size for every fixed number of training passes without replacement.

In some embodiments of the invention, the above-described method and system includes, wherein the ML models to be trained are generated, scheduled for training, evaluated, and ranked by an automated hyperparameter optimization (HPO) system. An HPO system automatically searches for the best hyperparameter settings in a provided ML model that has unspecified hyperparameters. It uses a provided search space specification and built-in hyperparameter optimization methods, for example Hyperopt and Hyperband, to select the hyperparameter settings that perform well on the validation set. The HPO system generates a sequence of training jobs, each training job including a setting for hyperparameters and a time limit or/and resource budget for training the ML model. Each training job then gets executed by the system described above. The HPO system uses the performance of earlier training jobs to guide the generation of later training jobs, giving more resources to better-performing hyperparameter configurations.

Embodiments of the invention use model-independent training subset selection methods that moves much of the computation for subset selection into the preprocessing step and shares it across all training jobs, making HPO more efficient. Higher-quality selected subsets let the HPO system detect performant hyperparameter configurations earlier and under tighter budgets.

In some embodiments of the invention, the above-described method and system includes, the ML models being generated, scheduled for training, evaluated, and ranked by an automated AI (AutoAI) system. An AutoAI system automatically assembles ML models from operators via pipeline architecture search and uses HPO methods as described above to select the ML model that performs well on the validation set. Such a system includes a library of ML and non-ML operators, a search space specification, a set of hyperparameter optimization methods, and a component for pipeline selection and tuning. The AutoAI system generates a sequence of training jobs, each training job including an ML model, its hyperparameter setting, and a time limit or/and resource budget for its training. Each training job then gets executed by the system described in accordance with embodiments of the invention. The AutoAI system uses the performance of earlier training jobs to guide the generation of later training jobs, giving more resources to better-performing model configurations.

Embodiments of the invention use model-independent training subset selection methods that are guided by a schedule of subset quality measures places no restriction on the ML model specified in a training job, thus its preprocessing step is shared across all ML models, making the AutoAI system more efficient. Higher-quality selected subsets let the AutoAI system detect performant model configurations earlier and under tighter budgets.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method operable to use a processor system electronically coupled to a memory to perform processor system operations comprising:
executing a model-independent selection (MIS) algorithm to select a first data subset from a first dataset based at least in part on one or more data quality metrics;
wherein the one or more data quality metrics comprise a first data quality metric that results from using a first function to map first data points of the first dataset to the first data quality metric;
wherein executing the MIS algorithm to select the first data subset from the first dataset is further based at least in part on sampling the first data subset from the first dataset based on a probability distribution; and
providing the first data subset to a to-be-trained (TBT) model;
wherein the first function is independent of a type of the TBT model.

2. The computer-implemented method of claim 1, wherein the probability distribution comprises a bias toward achieving a greater value of the first data quality metric.

3. The computer-implemented method of claim 1, wherein the first data quality metric comprises a diverse-data metric.

4. The computer-implemented method of claim 1, wherein the first data quality metric comprises a representation-related metric.

5. The computer-implemented method of claim 1, wherein:
the one or more data quality metrics further comprise a second data quality metric that results from using a second function to map second data points of the first dataset to the second data quality metric;
the second function is independent of the type of the TBT model;
the first data quality metric is associated with a first model-training characteristic (MTC);
the second data quality metric is associated with a second MTC;
the first MTC is different from the second MTC; and
executing the MIS algorithm to select the first data subset from the first dataset is further based at least in part on the first MTC and the second MTC.

6. The computer-implemented method of claim 5, wherein:
the first data quality metric comprises a diverse-data metric;
the second data quality metric comprises a representation-related metric;
the first MTC comprises a first range of model training speeds; and
the second MTC comprises a second range of model training speeds.

7. The computer-implemented method of claim 1, wherein executing the MIS algorithm to select the first data subset from the first dataset is further based at least in part on one or more data selection constraints.

8. The computer-implemented method of claim 7, wherein the one or more data selection constraints comprise a training stage associated with the TBT model.

9. The computer-implemented method of claim 1, wherein:
the processor system operations further comprise performing preprocessing operations on the first dataset to generate data structures of the first dataset matched to the first function; and
executing the MIS algorithm to select the first data subset from the first dataset is further based at least in part on the data structures.

10. The computer-implemented method of claim 1, wherein a total number of the first data points of the first dataset is less than a total number of data points of the first dataset.

11. A computer system comprising a processor system electronically coupled to a memory, wherein the processor system is operable to perform processor system operations comprising:
executing a model-independent selection (MIS) algorithm to select a first data subset from a first dataset based at least in part on one or more data quality metrics;
wherein the one or more data quality metrics comprise a first data quality metric that results from using a first function to map first data points of the first dataset to the first data quality metric;
wherein executing the MIS algorithm to select the first data subset from the first dataset is further based at least in part on sampling the first data subset from the first dataset based on a probability distribution; and
providing the first data subset to a to-be-trained (TBT) model;
wherein the first function is independent of a type of the TBT model.

12. The computer system of claim 11, wherein the probability distribution comprises a bias toward achieving a greater value of the first data quality metric.

13. The computer system of claim 11, wherein the first data quality metric comprises a diverse-data metric.

14. The computer system of claim 11, wherein the first data quality metric comprises a representation-related metric.

15. The computer system of claim 11, wherein:
the one or more data quality metrics further comprise a second data quality metric that results from using a second function to map second data points of the first dataset to the second data quality metric;
the second function is independent of the type of the TBT model;
the first data quality metric is associated with a first model-training characteristic (MTC);
the second data quality metric is associated with a second MTC;
the first MTC is different from the second MTC; and
executing the MIS algorithm to select the first data subset from the first dataset is further based at least in part on the first MTC and the second MTC.

16. The computer system of claim 15, wherein:
the first data quality metric comprises a diverse-data metric;
the second data quality metric comprises a representation-related metric:
the first MTC comprises a first range of model training speeds; and
the second MTC comprises a second range of model training speeds.

17. The computer system of claim 11, wherein executing the MIS algorithm to select the first data subset from the first dataset is further based at least in part on one or more data selection constraints.

18. The computer system of claim 17, wherein the one or more data selection constraints comprise a training stage associated with the TBT model.

19. The computer system of claim 11, wherein:
the processor system operations further comprise performing preprocessing operations on the first dataset to generate data structures of the first dataset matched to the first probability distribution function; and
executing the MIS algorithm to select the first data subset from the first dataset is further based at least in part on the data structures.

20. A computer program product comprising a computer readable program stored on a computer readable storage medium, wherein the computer readable program, when executed on a processor system, causes the processor system to perform processor system operations comprising:
executing a model-independent selection (MIS) algorithm to select a first data subset from a first dataset based at least in part on one or more data quality metrics;
wherein the one or more data quality metrics comprise a first data quality metric that results from using a first function to map first data points of the first dataset to the first data quality metric; and
providing the first data subset to a to-be-trained (TBT) model;
wherein the first function is independent of a type of the TBT model;
wherein executing the MIS algorithm to select the first data subset from the first dataset is further based at least in part on sampling the first data subset from the first dataset based on a probability distribution having a bias toward achieving a greater value of the first data quality metric;
wherein the one or more data quality metrics further comprise a second data quality metric that results from using a second function to map second data points of the first dataset to the second data quality metric;
wherein the second function is independent of the type of the TBT model;
wherein the first data quality metric is associated with a first model-training characteristic (MTC);
wherein the second data quality metric is associated with a second MTC;
wherein the first MTC is different from the second MTC;
wherein executing the MIS algorithm to select the first data subset from the first dataset is further based at least in part on the first MTC and the second MTC;
wherein executing the MIS algorithm to select the first data subset from the first dataset is further based at least in part on one or more data selection constraints; and
wherein the one or more data selection constraints comprise a training stage associated with the TBT model.
